(19) United States
(12) Patent Application Publication
(10) Pub. No.: US 2024/0378858 A1
(43) Pub. Date: Nov. 14, 2024

(54) TRAINING GENERATIVE MODELS FOR GENERATING STYLIZED CONTENT

(71) Applicant: Accenture Global Solutions Limited, Dublin (IE)

(72) Inventors: Jordan Alexander Ackerman, San Francisco, CA (US); Michael Kuniavsky, San Francisco, CA (US)

(21) Appl. No.: 18/650,460

(22) Filed: Apr. 30, 2024

Related U.S. Application Data
(60) Provisional application No. 63/499,401, filed on May 1, 2023.

(51) Int. Cl. G06V 10/762; G06T 11/00; G06V 10/774; G06V 10/778

(52) U.S. Cl. CPC G06V 10/763; G06T 11/00; G06V 10/7747; G06V 10/7788

(57) ABSTRACT

Methods, computer systems, and apparatus, including computer programs encoded on computer storage media, for training a generative machine-learning model. The system obtains a plurality of training images, groups the training images into a plurality of image clusters, and for each respective image cluster, generates a respective set of instances of the generative machine-learning model based on the training images in the image cluster.

### CROSS-REFERENCE TO RELATED APPLICATION

This application claims priority to U.S. Provisional Patent Application No. 63/499,401, filed on May 1, 2023, the disclosure of which is hereby incorporated by reference in its entirety.

### TECHNICAL FIELD

This specification relates to generative machine-learning models for generating stylized digital components.

### BACKGROUND

Generative models are types of machine learning models that can generate a digital component, such as an image, a video, or text, based on a model input, e.g., a text prompt describing the digital component to be generated. One example of a generative model is a Stable Diffusion (SD) model. SD is a type of diffusion process that is used to generate images with high visual fidelity, where the model learns to iteratively refine an initial noisy image to generate a realistic output image.

### SUMMARY

This specification describes computer-implemented systems and methods for training a generative machine-learning model for generating digital components (e.g., images, audio, videos, and text) that adhere to particular styles and/or standards. For brevity and ease of description, the following description is provided in the context of generating stylized images; however, the described techniques can also be used to generate other types of digital components, such as videos, audios, or text.

Throughout this specification, an “embedding” of an entity (e.g., a model input) can refer to a representation of the entity as an ordered collection of numerical values, e.g., a vector, matrix, or other tensor of numerical values.

Throughout this specification, a “digital component” refers to a discrete unit of digital content or digital information (e.g., a video clip, audio clip, multimedia clip, gaming content, image, text, combination of image and text, or another unit of content or unit of combined content). A digital component can electronically be stored in a physical memory device as a single file or in a collection of files, and digital components can take the form of video files, audio files, multimedia files, image files, or text files.

Throughout this specification, an “instance” of a machine learning model refers to a specific version of the model, ready to be used for tasks such as prediction, classification, or generative tasks. Different instances of a same machine learning model have the same model architecture and operation flow, but can include different values for one or more model parameters and/or components.

In one particular aspect, the specification provides a training method for training a generative machine-learning model configured to generate an image based on an input (e.g., a text prompt). The training method can be performed by a system implemented as one or more computer programs on one or more computers in one or more locations.

The system obtains a plurality of training images, groups the training images into a plurality of image clusters, and for each respective image cluster, generates a respective set of instances of the generative machine-learning model based on the training images in the image cluster. In particular, In particular, for each of a set of intensity levels, the system generates a respective instance of the generative machine-learning model by conditioning the generative machine-learning model based on (i) the image cluster and (ii) a respective embedding size determined from the respective intensity level.

In some implementations, the system further receives an input specifying a prompt that includes (i) a descriptor, and (ii) an intensity level, selects one of the instances of the generative machine-learning model based on the specified descriptor and the specified style intensity level, and uses the selected instance of the generative machine-learning model to generate the output image.

In some implementations, the system uses K-means clustering to group the training images into the image clusters. In some implementations, the system uses human labeling to group the training images into the image clusters.

In some implementations, after grouping the training images into the plurality of image clusters, the system pre-processes each image cluster by performing one or more of: creating flipped copies, splitting oversized images, performing auto-focal point cropping, performing auto-sized cropping, or automatically generating captions.

In some implementations, the intensity level is a style intensity level that characterizes a specificity to a particular image style for a generated image. For example, the intensity level can be a style intensity level that characterizes a specificity to a particular image style for a generated image. In another example, the intensity level can be a subject intensity level that characterizes a specificity to a particular subject for a generated image.

In some implementations, the generative machine-learning model comprises a diffusion model and a textual inversion component. The respective embedding size is a dimension number of a respective textual inversion embedding vector for the respective image cluster and the respective intensity level. For each respective image cluster and for each respective intensity level, the system determines the respective textual inversion embedding vector based on (i) the respective image cluster and (ii) the respective intensity level.

In some implementations, for each respective image cluster, the system further determines a respective descriptor corresponding to the textual inversion embedding vectors determined for the respective set of instances of the generative machine-learning model, and adds the respective descriptor to a new descriptor vocabulary. The respective descriptor can be determined using: expert-defined vocabulary, human image captions, automatic image captions, or automatically identified image features.

In some implementations, before generating the instances of the generative machine-learning model, the generative machine-learning model has been pre-trained on one or more general training data sets.

In some implementations, after generating the instances of the generative machine-learning model, the system finetunes the instances of the generative machine-learning model using feedback data. In some cases, the feedback data is human-provided feedback. In some cases, the system performs performing reinforcement learning to finetune the model using the feedback data as a reward signal.

In another aspect, this specification provides a system comprising one or more computers and one or more storage devices storing instructions that when executed by the one or more computers cause the one or more computers to perform the training method described above.

In another aspect, this specification provides one or more non-transitory computer storage media encoded with instructions that, when executed by one or more computers, cause the one or more computers to perform the training method described above.

The subject matter described in this specification can be implemented in particular embodiments so as to realize one or more of the following advantages.

Conventional generative models using text prompts may generate digital components, but they still suffer from certain drawbacks. One of the main challenges with these models is their reliance on elaborate text prompts to generate output. This approach can be brittle and requires a great deal of effort to produce the desired results. Additionally, the generated output is often limited by the specific style template used, providing very little flexibility. Overall, these limitations can restrict the creativity and diversity of the generated output, making it difficult to apply these models in various fields such as media production, design, and creative writing.

The techniques described herein overcome the challenges of the conventional generative models, and provide a solution for generating digital components such as images, videos, audio, and text that adhere to user-specified standards and styles while still allowing for flexibility and creativity. This is achieved by ingesting a library of images and automatically clustering them, creating a controlled set of descriptors of styles or subjects from these clusters, and training a generative machine-learning model for each descriptor in the controlled set. The generative machine-learning model is trained in multiple versions to capture the full spectrum of intensity and flexibility for each style and/or subject, resulting in a total output of dozens or hundreds of models. This allows for a large number of variations of existing assets with complex and nested style guidelines that meet diverse criteria.

### BRIEF DESCRIPTION OF THE DRAWINGS

FIG. 1 shows an example artificial intelligence system for providing an automatically synthesized digital component in response to a user request.

FIG. 2 shows an example training system for training a generative machine-learning model.

FIG. 3 is a flow diagram illustrating an example process for training a generative model.

FIG. 4 is a flow diagram illustrating an example process for generating an image using a generative model.

FIG. 5 shows an example computer system for performing operations for evaluating and optimizing the energy efficiency of computer code snippets.

Like reference numbers and designations in the various drawings indicate like elements.

### DETAILED DESCRIPTION

This specification provides techniques for training a generative machine-learning model for generating digital components (e.g., images, audio, videos, and text) that adhere to particular styles, standards, and/or subjects.

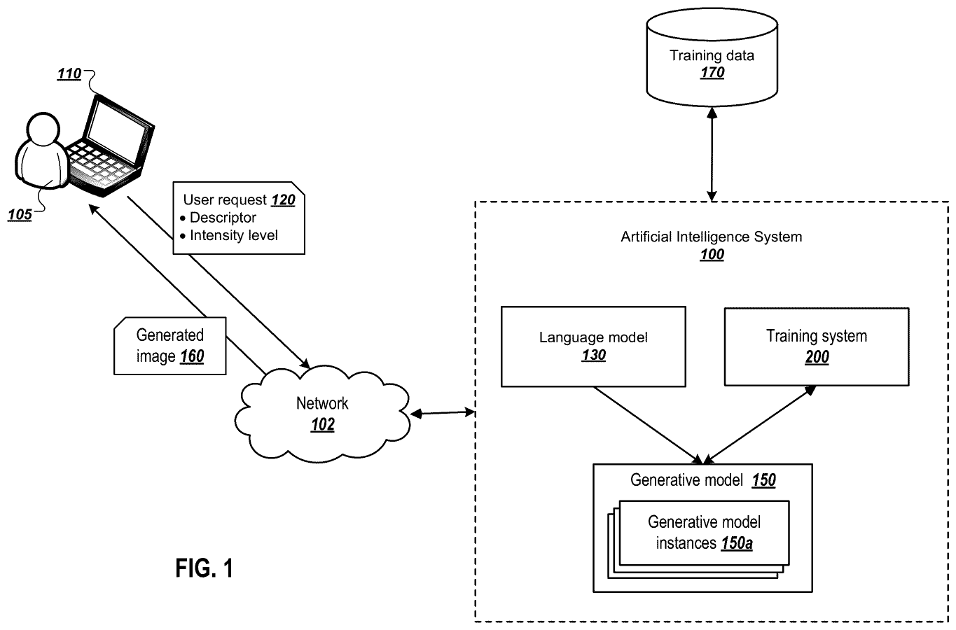

FIG. 1 illustrates an example environment in which generative artificial intelligence is implemented. The example environment includes a network 102, such as a local area network (LAN), a wide area network (WAN), the Internet, or a combination thereof. The network 102 connects a user device 110 of a user 115, and an artificial intelligence (AI) system 100.

A user device 110 is an electronic device capable of requesting and receiving online resources over the network 102. Example user devices can include personal computers, gaming devices, mobile communication devices, tablet devices, digital assistant devices, augmented reality devices, virtual reality devices, wearable devices, and other devices that can send and receive data over the network 102. The user device 110 typically includes a user application, such as a web browser, to facilitate the sending and receiving of data over the network 102, but native applications (other than browsers) executed by the user device 110 can also facilitate the sending and receiving of data over the network 102.

The user device 110 can send, e.g., via the user application, a request 120 to another system connected to the network 102. The request 120 can be a request for a digital component and can include descriptions and requirements for the requested digital component. The user device 110 can receive a digital component from the network 102 and display the digital component via the application.

The artificial intelligence system 100 is configured to autonomously generate digital components, such as images, texts, videos, and audio items. The artificial intelligence system 100 can be implemented in a distributed computing system that includes, for example, a server and a set of multiple computing devices that are interconnected.

The system 100 includes a language model 130, a generative model 150, and a training system 200. In response to receiving the request 120 from the user device 110, the system 100 can use the language model 130 to process the request 120 to generate a representation of the request 120 and use the generative model 150 to generate the digital components that complies with the descriptions and requirements in the request 120. The system 100 can then send the generated digital component, e.g., the generated image 160, through the network 102 to the user device 110 for presentation. The training system 200 is configured to train and/or condition the generative model 150 using the training data 170.

In FIG. 1, the language model 130, the generative model 150, and the training system 200 are depicted as integrated into the artificial intelligence system 100. However, one or more of these components can also be separated from the artificial intelligence system 100 and connected with the other components via the network 102.

The language model 130 is a model that is trained to understand (and optionally, generate) human language. The language model 130 can be implemented with any appropriate language model and is configured to receive an input sequence made up of text tokens selected from a vocabulary and generate an output representation of the input sequence. The output representation generated by the language model 130 can be used to condition the generative model 150.

In general, language models are trained on datasets of text and code, and they can be used for a variety of tasks. For example, language models can be trained to translate text from one language to another; summarize text, such as website content, search results, news articles, or research papers; answer questions about text; create chatbots that can have conversations with humans; and generate creative text, such as poems, stories, and code.

In some cases, the language model 130 can include a Transformer-based language model neural network or a recurrent neural network-based language model. As a particular example, the language model 130 can include a decoder-only Transformer architecture with bidirectional encoder representations. Example implementations of the bidirectional encoder representations from Transformers can be found in Devlin, et al., “BERT: pre-training of deep bidirectional transformers for language understanding,” CoRR, abs/1810.04805, 2018. 7.

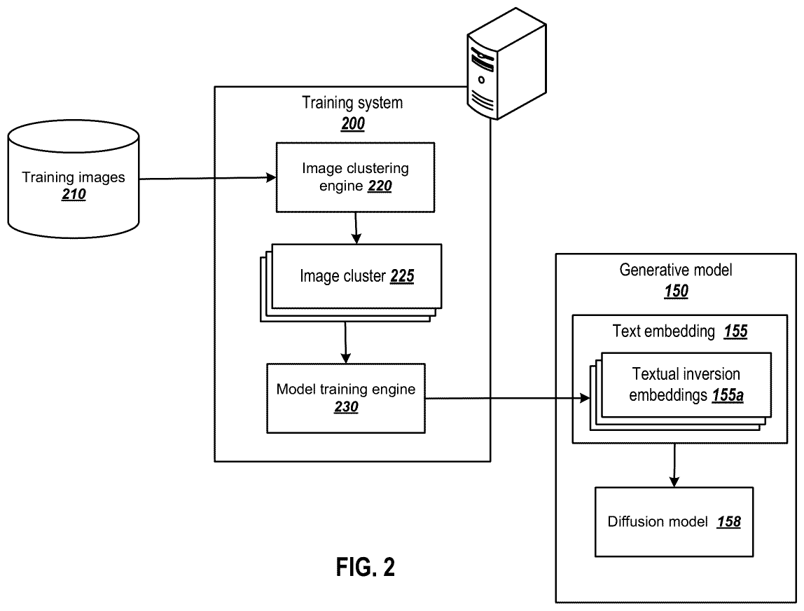

The generative model 150 is configured to generate the requested digital component conditioned by the output representation generated by the language model 130. Some example implementations and operations of the generative model 150 are described in more detail below with reference to FIG. 2. In general, the training system 200 can generate multiple instances 150a of the generative model 150, with each instance being adapted to a particular application scenario. The system 100 can select a particular instance 150a of the generative model 150 to generate the digital component to satisfy the user request 120.

For example, the user request 120 can include a descriptor that specifies (i) a particular style or a particular subject and (ii) an intensity level that characterizes a specificity to the particular style or the particular subject. The system 100 can select one of the instances 150a of the generative model based on the specified descriptor and the specified style intensity level, and uses the selected instance 150a to generate the digital component.

FIG. 2 shows an example environment in which a training system 200 performs training of a machine-learning model, e.g., the generative model 150. The system 200 is an example of a system implemented as computer programs on one or more computers in one or more locations, in which the systems, components, and techniques described below can be implemented.

The training system 200 includes an image clustering engine 220 and a model training engine 230. The image clustering engine is configured to receive a set of training images 210 and group the training images 210 into a plurality of image clusters 225, with each respective image cluster 225 including a respective subset of the training images. The model training engine is configured to use the image clusters 225 to generate a plurality of instances of the generative model 150.

In general, the training images 210 can include images depicting diverse subjects and having diverse styles. The training images 210 can be obtained in any of a number of different ways. These can include photo and creative artwork collections, publicly available image datasets, and/or machine-generated images (for the latter two, usage may be premised on appropriate licensing terms).

The image clustering engine 220 can group the training images 210 in any of several different ways. In general, the result of clustering is a set of image clusters 225 where each cluster represents a certain style, subject, theme, or visual concept. Each image cluster 225 can include any appropriate number of images. For example, an image cluster 225 can include 3-5 images, 3-10 images, 10-100 images, or 100-1000 images.

In some implementations, the image clustering engine 220 can parse the plurality of training images 210 to identify a plurality of style, subject, theme, or visual concept features. These features can be based on one or more attributes, such as, e.g.: contrast (the difference in brightness between different parts of an image), saturation (the intensity of colors in an image), hue (the dominant color in an image), edge detection (identifying the edges of objects in an image), texture analysis (identifying different textures within an image), shape analysis (identifying the shapes of objects in an image), motion detection (identifying movement or changes within an image), object recognition (identifying specific objects within an image), facial recognition (identifying faces and facial features within an image), emotion recognition (identifying emotions expressed in facial expressions within an image), image segmentation (separating an image into different regions or objects), object counting (counting the number of specific objects within an image), object tracking (tracking the movement of specific objects within an image), optical character recognition (identifying and recognizing text within an image), image compression (reducing the size of an image while maintaining its quality), image retrieval (finding similar images to a given image in a database based on their visual features), average pixel intensity (the average brightness value of all the pixels in an image), sharpness (the overall clarity or focus of an image, measured by the degree of contrast at edges), blurriness (the degree to which an image is out of focus or blurred), noise (the amount of random variation in brightness or color in an image), contrast ratio (the ratio of the brightness of the brightest and darkest parts of an image), saturation level (the level of color intensity in an image), entropy (the level of randomness or disorder in an image), standard deviation (the amount of variation in pixel intensity values in an image), image complexity (a measure of the number of distinct visual features or objects in an image), aspect ratio (the ratio of the width to height of an image), skewness (a measure of the asymmetry of the pixel intensity distribution in an image), kurtosis (a measure of the peakedness of the pixel intensity distribution in an image), fractal dimension (a measure of the complexity or roughness of the structure in an image), moment of inertia (a measure of the distribution of mass in an image).

In some implementations, the image clustering engine 220 can implement a computational technique, such as the K-means clustering technique, to generate the image clusters 225. The K-means clustering technique performs an unsupervised partitioning of an image dataset into a number (K) of clusters. In particular, each training image 210 is represented by a feature vector, which is a numerical vector with each dimension characterizing one of the image features, such as the features discussed above. In some cases, the feature vectors can be generated using an image representation model that has been trained to effectively represent an input image in the feature space.

The image clustering engine 220 selects K data points (feature vectors) for selected training images 210 to serve as initial cluster centroids, representing estimated central tendencies within the feature space. The image clustering engine 220 then performs an iterative process including (i) assigning each training image to the closest centroid and (ii) updating each centroid as the mean of all data points assigned to its respective cluster.

The number of clusters (K) can be determined in any of a variety of ways. In some cases, K can be predefined by an expert based on domain knowledge. In some other cases, K can be dynamically determined using computational techniques. One such technique is the Elbow algorithm, which analyzes the decrease in within-cluster variance as the number of clusters increases, looking for a distinct “bend” in the graph to suggest a suitable cluster count. In another example, the Silhouette algorithm can be used to evaluate the fit of data points within their assigned clusters compared to neighboring clusters, with higher average Silhouette scores indicating a more appropriate number of clusters.

In some implementations, the image clustering engine 220 can use image labels to group the training images 210. For example, a labeler (human or machine) can provide annotations to at least a subset of the training images 210 to describe the image features, and the image clustering engine 220 can group the images according to their assigned label. In some cases, the image clustering engine 220 can combine machine learning techniques with image labels to perform the clustering. For example, an image classification model can be trained on the subset of labeled images and used to determine the classification of the unlabeled images.

In some implementations, after grouping the training images 210 into the image clusters 225, the image clustering engine 220 can pre-process each image 225 cluster, e.g., creating flipped copies, splitting oversized images, performing auto-focal point cropping, performing auto-sized cropping, or automatically generating captions.

The generative model 150 can be any appropriate generative machine-learning model. In some implementations, the generative model 150 includes a diffusion model 158, which is a probabilistic model configured to gradually denoise a normally distributed variable. The diffusion model 158 can be implemented by a sequence of denoising autoencoders, each of which is trained to predict a denoised variant of its respective input. The diffusion model 158 can be conditioned by a text embedding 155 (e.g., generated from a text prompt) to generate an image with particular characteristics described by the text. In some cases, the text embedding 155 can be generated by tokenizing an input prompt into a set of tokens that are indexed in a predefined dictionary and then processing the tokens using a text encoder. Each token is linked to a unique embedding vector that can be retrieved through an index-based lookup. Replacing a token embedding (e.g., an embedding of a prompt specifying a first object) with another token embedding (e.g., an embedding of a prompt specifying a second object) will result in a different image being generated by the diffusion model 158.

In a particular example, the generative model 150 can include a stable diffusion model. The stable diffusion model performs the diffusion process in a low-dimension latent space instead of the image pixel space, and can significantly reduce computational requirements compared to pixel-based diffusion models. Examples of implementation of the stable diffusion model can be found in Rombach et al. “High-Resolution Image Synthesis with Latent Diffusion Models,” International Conference on Computer Vision and Pattern Recognition (CVPR). New Orleans, LA. pp. 10684-10695. arXiv:2112.10752 (the content of which is incorporated by reference herein).

The diffusion model 158 can be conditioned by the text embedding 155 in any of several appropriate manners. In a particular example, the text embedding 155 can be inputted into a UNet model which is a sub-network of a stable diffusion model.

The model training engine 230 is configured to generate multiple instances of the generative model 150 based on the image clusters 225. In general, before model training engine 230 generates the instances of the generative model 150, the generative model has been pre-trained on one or more general training data sets that include a large number of images.

For each particular image cluster 225, the model training engine 230 generates a respective set of instances of the generative model 150 that specialize in generating images having a similar style, subject, theme, or visual concept as the images in the particular image cluster 225. The respective set of instances of the generative model 150 correspond to a set of intensity levels, with each model instance corresponding to a particular intensity level. The intensity level controls how closely the generated images adhere to the cluster's characteristics. A high intensity level results in images that strongly reflect the specific style, subject, theme, or visual concept, while a low intensity level allows for a more subtle incorporation of its traits. In some cases, the set of intensity levels can include numerical levels such as 0.1, 0.2, 0.3, etc. In some other cases, the set of intensity levels can include labels such as “low”, “medium”, and “high”.

In general, for each intensity level, the model training engine 230 generates a respective instance of the generative model 150 by conditioning the generative model based on (i) the corresponding image cluster and (ii) a respective embedding size determined from the respective intensity level.

In particular, the generative model 150 can include a diffusion model 158 and a textual inversion component 155a. In this case, the embedding size is a dimension number of a respective textual inversion embedding vector for the respective image cluster and the respective intensity level. For each respective image cluster and for each respective intensity level, the model training engine 230 can determine the respective textual inversion embedding vector 155a based on (i) the respective image cluster and (ii) the respective intensity level.

For a particular image cluster, an increased dimension number in the textual inversion embedding vector corresponds to an increased intensity level. In this case, the textual inversion embedding vector 155a acts as a control mechanism, with higher-dimensional embeddings enforcing a stricter alignment with the cluster's traits at higher intensity levels. The model training engine 230 can map different intensity levels to different dimension numbers of the textual inversion embedding vector using a pre-defined relationship. For example, a “low” intensity level can be mapped to K1 dimensions, a “medium” intensity level can be mapped to K2 dimensions, and a “high” intensity level can be mapped to K3 dimensions, where k1<k2<k3.

In the above description, each instance 150a of the generative model 150 includes (i) a particular textual inversion embedding vector 155a generated based on the respective image cluster and the respective intensity level and (ii) the diffusion model 158. In some cases, the diffusion model 158 has its parameters fixed at the pre-trained values for all instances 150a generated for the generative model 150. In some other cases, the parameters of the diffusion model 158 can be adjusted for different instances 150a of the model.

For a particular instance of the generative model 150, the diffusion model 158 can be conditioned by the corresponding textual inversion embedding vector 155a in the same manner as the diffusion model 158 is conditioned by a text embedding 155. In some cases, the textual inversion embedding vector 155a and the text embedding 155 can be in the same embedding space. However, the textual inversion embedding vector 155a is generated from the corresponding image cluster 225 and based on a specific intensity level while the text embedding 155 is generated by encoding a text prompt.

The model training engine 230 can determine the textual inversion embedding vector 155a for a particular image cluster 255 and a particular intensity level using an optimization process, e.g., by minimizing a diffusion model loss for a reconstruction task using the training images in the particular image cluster 255. As discussed above, in some cases, the parameters of the diffusion model 258 can be fixed to the pre-trained values while the textual inversion embedding vector 155a is being optimized. In some other cases, at least a subset of parameters of the diffusion model 258 can be updated with the textual inversion embedding vector 155a during optimization.

In some implementations, the model training engine 230 is further configured to determine a respective descriptor for each image cluster 255 corresponding to a set of textual inversion embedding vectors 155a representing different intensity values. The model training engine 230 can add the respective descriptor to a new descriptor vocabulary. The descriptors can be determined using any of a variety of manners, such as using expert-defined vocabulary, human image captions, automatic image captions, or automatically identified image features.

After generating the instances 150a of the generative model 150 using the image clusters 225, the system 200 or another system (e.g., the system 100 of FIG. 1) can use the generated instances of the generative model to generate images. The system can receive an input specifying a descriptor and a style intensity level. The system can select one of the generated instances 150a of the generative model 150 based on the specified descriptor and the specified style intensity level, and uses the selected instance of the generative model to generate the output image. To select a particular instance 150a of the model 150, the system can map the descriptor included in the input to a new descriptor in the new descriptor vocabulary, which is mapped to a set of textual inversion embedding vectors 155a. The system can select a particular textual inversion embedding vector from the set of textual inversion embedding vectors 155a based on the specified intensity level.

In some implementations, after training the generative machine-learning model, the system 200 can further perform curation of the trained instances of the generative machine-learning model. For example, the system 200 can use a reinforcement learning process to learn which generated images meet specific standards. User feedback can be used as reward signals in the reinforcement learning process. This process can further allow for additional extraction and additional training of preferred and variant-controlled descriptors by observing user prompts.

To ensure that the generated images match user prompts and/or style standards (e.g., style standards of a brand, a business, an organization or another entity), the system 200 can analyze one or more image features of the generated image and compare them to images in a library. The system can compute scores based on one or more of: style similarity, style standards matching, and style standards violations. The system 200 can use the feedback from the user and/or the computed scores to finetune the instances 150a of the generative model 150 to improve the model performance.

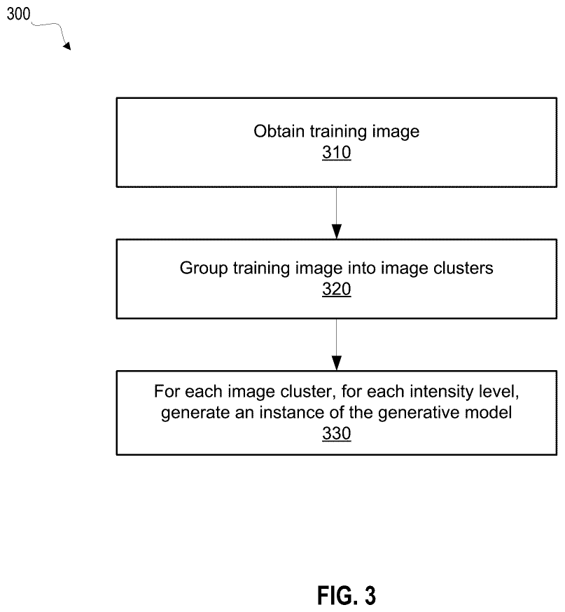

FIG. 3 is a flow diagram illustrating an example process 300 for training a generative model. For convenience, the process 300 will be described as being performed by a system of one or more computers located in one or more locations. For example, the system 100 described with reference to FIG. 1, and/or the system 200 described with reference to FIG. 2, appropriately programmed in accordance with this specification, can perform the process 300.

At 310, the system obtains a plurality of training images. The training images can include images depicting diverse subjects and having diverse styles, and can be obtained in any of a number of different ways as described above with reference to FIG. 2.

At 320, the system groups the training images into a plurality of image clusters. Each respective image cluster includes a respective subset of the training images. In some implementations, the system uses K-means clustering to group the training images into the image clusters. In some implementations, the system uses human labeling to group the training images into the image clusters. Further details of clustering the training images are described above with reference to FIG. 2.

In some implementations, after grouping the training images into the plurality of image clusters, the system pre-processes each image cluster by performing one or more of: creating flipped copies, splitting oversized images, performing auto-focal point cropping, performing auto-sized cropping, or automatically generating captions.

At 330, for each respective image cluster, the system generates a respective set of instances of the generative machine-learning model based on the training images in the image cluster. In particular, for each of a set of intensity levels, the system generates a respective instance of the generative machine-learning model by conditioning the generative machine-learning model based on (i) the image cluster and (ii) a respective embedding size determined from the respective intensity level.

In some implementations, the intensity level is a style intensity level that characterizes a specificity to a particular image style for a generated image. For example, the intensity level can be a style intensity level that characterizes a specificity to a particular image style for a generated image. In another example, the intensity level can be a subject intensity level that characterizes a specificity to a particular subject for a generated image.

In some implementations, the generative machine-learning model comprises a diffusion model and a textual inversion component. The respective embedding size is a dimension number of a respective textual inversion embedding vector for the respective image cluster and the respective intensity level. For each respective image cluster and for each respective intensity level, the system determines the respective textual inversion embedding vector based on (i) the respective image cluster and (ii) the respective intensity level.

In some implementations, for each respective image cluster, the system further determines a respective descriptor corresponding to the textual inversion embedding vectors determined for the respective set of instances of the generative machine-learning model, and adds the respective descriptor to a new descriptor vocabulary. The respective descriptor can be determined using: expert-defined vocabulary, human image captions, automatic image captions, or automatically identified image features.

In some implementations, before generating the instances of the generative machine-learning model, the generative machine-learning model has been pre-trained on one or more general training data sets.

In some implementations, after generating the instances of the generative machine-learning model, the system finetunes the instances of the generative machine-learning model using feedback data. In some cases, the feedback data is human-provided feedback. In some cases, the system performs performing reinforcement learning to finetune the model using the feedback data as a reward signal.

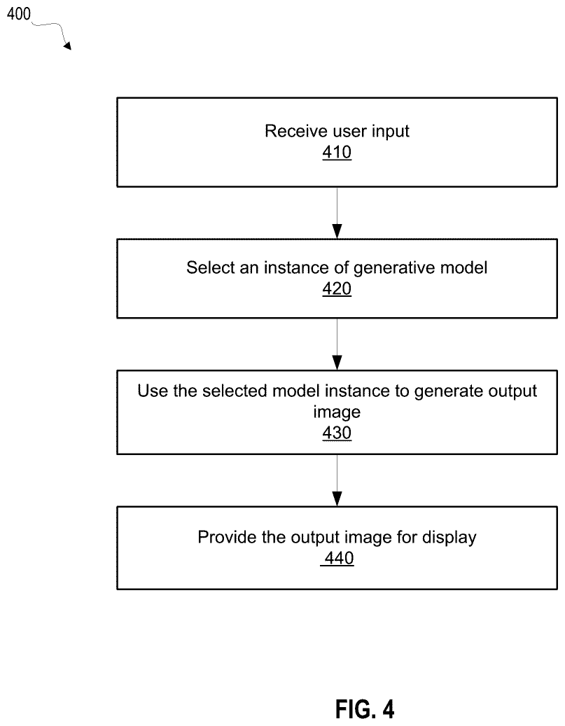

FIG. 4 is a flow diagram illustrating an example process 400 for generating an image using a generative model. For convenience, the process 400 will be described as being performed by a system of one or more computers located in one or more locations. For example, the system 100 described with reference to FIG. 1, and/or the system 200 described with reference to FIG. 2, appropriately programmed in accordance with this specification, can perform the process 400.

At 410, the system receives an input specifying a prompt that includes (i) a descriptor, and (ii) an intensity level. The input can be received from a user device that includes an interface and an application. Further details of the user device are described above with reference to FIG. 1 and FIG. 2.

At 420, the system selects one of the instances of the generative machine-learning model based on the specified descriptor and the specified style intensity level. As described in further detail above with reference to FIG. 2, the system can the system can map the descriptor included in the input to a new descriptor in the new descriptor vocabulary, and use the new descriptor and the intensity level to identify the selected instance of the generative machine-learning model.

At 430, the system uses the selected instance of the generative machine-learning model to generate an output image. As described in further detail above with reference to FIG. 2, the selected instance of the generative machine-learning model includes (i) a corresponding textual inversion embedding that maps to the descriptor and the intensity level specified in the input, and (ii) a diffusion model that is configured to generate the output image, conditioned by the corresponding textual inversion embedding.

At 440, the system provides the output image to a user device for display. For example, as described in further detail with reference to FIG. 1 and FIG. 2, the system can provide the output image over a network to the user device, and the user device can display the output image via an application installed on the user device.

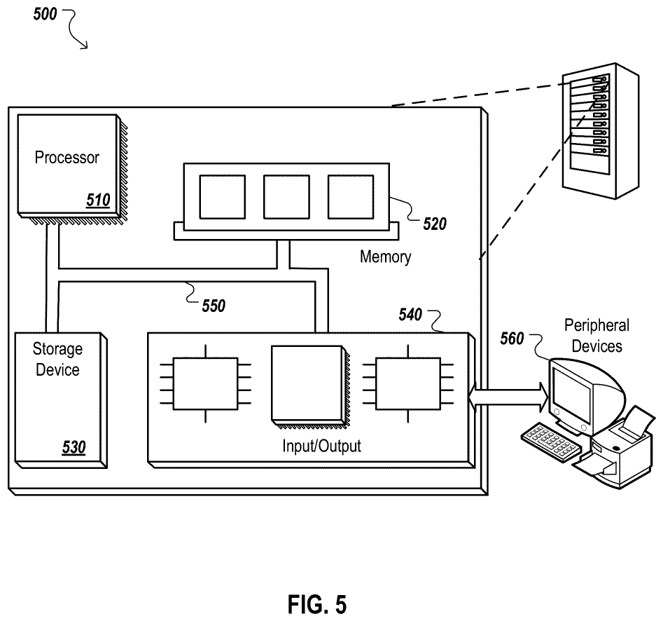

FIG. 5 shows an example computer system 500 that can be used to perform certain operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various implementations, the storage device 530 can include, for example, a hard disk device, an optical disk device, a storage device that is shared over a network by multiple computing devices (for example, a cloud storage device), or some other large-capacity storage device.

The input/output device 540 provides input/output operations for the system 500. In one implementation, the input/output device 540 can include one or more network interface devices, for example, an Ethernet card, a serial communication device, for example, a RS-232 port, and/or a wireless interface device. In another implementation, the input/output device can include driver devices configured to receive input data and send output data to other input/output devices, for example, keyboard, printer, and display devices 560. Other implementations, however, can also be used, such as mobile computing devices, mobile communication devices, set-top box television client devices, etc.

Although an example system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by a data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, that is, one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, for example, a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, for example, an FPGA (field programmable gate array) or an ASIC (application-specific integrated circuit). The apparatus can optionally include, in addition to hardware, code that creates an execution environment for computer programs, for example, code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, for example, an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device, for example, a universal serial bus (USB) flash drive, to name just a few.

Computer-readable media suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks.

To provide for interaction with a user, embodiments of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of messages to a personal device, for example, a smartphone that is running a messaging application and receiving responsive messages from the user in return.

Data processing apparatus for implementing machine learning models can also include, for example, special-purpose hardware accelerator units for processing common and compute-intensive parts of machine learning training or production, that is, inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, for example, as a data server, or that includes a middleware component, for example, an application server, or that includes a front-end component, for example, a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, for example, a communication network. Examples of communication networks include a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, for example, an HTML page, to a user device, for example, for purposes of displaying data to and receiving user input from a user interacting with the device, which acts as a client. Data generated at the user device, for example, a result of the user interaction, can be received at the server from the device.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for conditioning a generative machine-learning model configured to generate an image based on an input, the method comprising:
obtaining a plurality of training images;
grouping the training images into a plurality of image clusters, wherein each respective image cluster includes a respective subset of the training images;
for each respective image cluster:
generating a respective set of instances of the generative machine-learning model based on the training images in the image cluster, the generating comprising:
for each of a set of intensity levels, generating a respective instance of the generative machine-learning model by conditioning the generative machine-learning model based on (i) the image cluster and (ii) a respective embedding size determined from the respective intensity level.

2. The method of claim 1, further comprising generating an output image using the generated instances of the generative machine-learning model, the generating comprising:
receiving an input specifying a prompt that includes (i) a descriptor, and (ii) an intensity level;
selecting one of the instances of the generative machine-learning model based on the specified descriptor and the specified style intensity level; and
using the selected instance of the generative machine-learning model to generate the output image.

3. The method of claim 1, wherein the intensity level is a style intensity level that characterizes a specificity to a particular image style for a generated image.

4. The method of claim 1, wherein the intensity level is a subject intensity level that characterizes a specificity to a particular subject for a generated image.

5. The method of claim 1, wherein the generative machine-learning model comprises a diffusion model and a textual inversion component, wherein the respective embedding size is a dimension number of a respective textual inversion embedding vector for the respective image cluster and the respective intensity level.

6. The method of claim 5, further comprising:
for each respective image cluster and for each respective intensity level, determining the respective textual inversion embedding vector based on (i) the respective image cluster and (ii) the respective intensity level.

7. The method of claim 6, wherein for a particular image cluster, an increased dimension number in the textual inversion embedding vector corresponds to an increased intensity level.

8. The method of claim 6, further comprising:
for each respective image cluster, determining a respective descriptor corresponding to the textual inversion embedding vectors determined for the respective set of instances of the generative machine-learning model, and adding the respective descriptor to a new descriptor vocabulary.

9. The method of claim 8, wherein the respective descriptor is determined using: expert-defined vocabulary, human image captions, automatic image captions, or automatically identified image features.

10. The method of claim 1, wherein grouping the training images into the plurality of image clusters comprises:
using K-means clustering to group the training images into the image clusters.

11. The method of claim 1, wherein grouping the training images into the plurality of image clusters comprises:
using human labeling to group the training images into the image clusters.

12. The method of claim 1, further comprising:
after grouping the training images into the plurality of image clusters and before generating the instances of the generative machine-learning model, pre-processing each image cluster, the pre-processing comprising one or more of: creating flipped copies, splitting oversized images, performing auto-focal point cropping, performing auto-sized cropping, or automatically generating captions.

13. The method of claim 1, wherein:
before generating the instances of the generative machine-learning model, the generative machine-learning model has been pre-trained on one or more general training data sets.

14. The method of claim 1, further comprising:
after generating the instances of the generative machine-learning model, finetuning the instances of the generative machine-learning model using feedback data.

15. The method of claim 14, wherein the feedback data is human-provided feedback.

16. The method of claim 14, wherein finetuning the instances of the generative machine-learning model comprises:
performing reinforcement learning using the feedback data as a reward signal.

17. A system comprising one or more computers and one or more storage devices storing instructions that when executed by the one or more computers cause the one or more computers to perform operations for conditioning a generative machine-learning model configured to generate an image based on an input, the operations comprising:
obtaining a plurality of training images;
grouping the training images into a plurality of image clusters, wherein each respective image cluster includes a respective subset of the training images;
for each respective image cluster:
determining a respective descriptor for the respective image cluster; and
generating a respective set of instances of the generative machine-learning model on the training images in the image cluster, the generating comprising:
for each of a set of intensity levels, generating a respective instance of the machine-learning model by conditioning the machine-learning model based on (i) the image cluster and (ii) a respective embedding size determined from the respective intensity level.

18. The system of claim 17, wherein the operations further comprise generating an output image using the generated instances of the generative machine-learning model, the generating comprising:
receiving an input specifying a prompt, a descriptor, and a style intensity level;
selecting one of the instances of the generative machine-learning model based on the specified descriptor and the specified style intensity level; and
processing a model input specifying the prompt using the selected instance of the machine-learning model to generate the output image.

19. The system of claim 17, wherein the generative machine-learning model is a diffusion model comprising a textual inversion component, wherein the respective embedding size is a dimension number of a respective textual inversion embedding vector for the respective image cluster and the respective intensity level.

20. One or more non-transitory computer-readable storage media storing instructions that when executed by one or more computers cause the one or more computers to perform operations for conditioning a generative machine-learning model configured to generate an image based on an input, the operations comprising:
obtaining a plurality of training images;
grouping the training images into a plurality of image clusters, wherein each respective image cluster includes a respective subset of the training images;
for each respective image cluster:
determining a respective descriptor for the respective image cluster; and
generating a respective set of instances of the generative machine-learning model on the training images in the image cluster, the generating comprising:
for each of a set of intensity levels, generating a respective instance of the machine-learning model by conditioning the machine-learning model based on (i) the image cluster and (ii) a respective embedding size determined from the respective intensity level.
